(19) United States
(12) Patent Application Publication
(10) Pub. No.: US 2011/0249718 A1
(43) Pub. Date: Oct. 13, 2011

(54) METHOD AND APPARATUS FOR CORRECTING PHASE ERRORS DURING TRANSIENT EVENTS IN HIGH-SPEED SIGNALING SYSTEMS

(75) Inventor: Jared L. Zerbe, Woodside, CA (US)

(73) Assignee: RAMBUS INC., Los Altos, CA (US)

(21) Appl. No.: 13/121,948

(22) PCT Filed: Dec. 29, 2009
(86) PCT No.: PCT/US09/69760

§ 371 Date: Mar. 30, 2011

Related U.S. Application Data
(60) Provisional application No. 61/142,006, filed on Dec. 31, 2008.

(51) Int. Cl. H04L 7/00; H04B 17/00

(52) U.S. Cl. 375/226; 375/371

(57) ABSTRACT

A system for dynamically correcting phase errors between data and a timing reference signal caused by a transient event during data communication between a transmitter and a receiver is described. During operation, the system stores one or more phase-offset values for the event in an offset table, wherein the constituent phase-offset values are associated with phase error caused by the event. Upon detecting a subsequent occurrence of the event, the system adjusts a phase relationship between the data and the timing reference signal based on the one or more phase-offset values.

### TECHNICAL FIELD

The present embodiments generally relate to techniques for communicating data between a transmitter and a receiver. More specifically, the present embodiments relate to a method and apparatus for dynamically correcting phase errors between data signals and associated timing reference signals induced by transient events.

### BACKGROUND

During high-speed data communications through a communication channel, the data being transmitted is often phase-aligned with a timing reference signal at the transmitter side of the channel; this timing reference signal can be a clock signal, a strobe signal, or other form of timing reference signal. Both the data and the timing reference signals are then transmitted over respective links to the receiver side of the channel, wherein the data signal is received and subsequently recovered using the timing reference signal. Maintaining the correct phase relationship between the data and timing reference signals in such high-performance channels often depends on stable operating conditions (e.g., voltage, temperature, etc.). However, when these operating conditions are disturbed, phase misalignments between the data and the timing reference signals arise which can degrade link performance.

In a system that communicates using such a communication link, transient events can occur when the system undergoes abrupt change in operating conditions. Examples of such transient events include, but are not limited to, changes in modes of operation (e.g., between standby/power-down mode and active/power-up mode), row access strobe (RAS) events, read-to-write or write-to-read bus turnarounds and some core refresh operations in memories, among others. These changes in the operating conditions can induce significant amounts of power-supply or reference noise, which can subsequently lead to performance-limiting phase-errors and high-frequency jitter. For example, RAS events can cause a voltage ringing of approximately 20% on the bulk bias voltage (Vbb) in a twin-well DRAM device, which translates into an approximately 20% unit interval (UI) phase shift. In another example, phase errors induced by power switching (on or off) can be a serious problem for low-power systems because such systems require frequent power mode transitions for power saving purposes. In another example, a transition in power mode can result in a 20% spike in the digital power supply used to supply power to clock buffer inverters, which can also create a 20% UI phase shift. Hence, there is a need for a technique to mitigate the effects of such transient phase-error disturbances.

### BRIEF DESCRIPTION OF THE FIGURES

FIG. 1 presents a block diagram illustrating a phase-error adjustment mechanism that dynamically compensates for phase error caused by a known transient event in a data communication system.

FIG. 2A presents a block diagram illustrating a source-synchronous communication system which uses a receiver-side data detector for data-clock synchronization.

FIG. 2B illustrates a time-series phase waveform which is disrupted by a 15% phase-error disturbance during a power-transition event.

FIG. 3 presents a block diagram illustrating a process for updating a lookup table associated with a transient event.

FIG. 4 presents a flowchart illustrating a process for updating a lookup table during a transient event and for compensating for the phase errors caused by the transient event.

FIG. 5 presents a block diagram illustrating a data communication system which uses a phase correction loop and a transmitter-side lookup table to provide phase compensation during a transient event

FIG. 6 presents a block diagram illustrating a data communication system having a phase correction loop and a lookup table located on a receiver.

FIG. 7 presents a block diagram illustrating a source synchronous master/slave data communication system having a transient-event phase correction loop and two lookup tables located on the master side of the system.

FIG. 8 presents a block diagram illustrating an embodiment of a memory system, which includes at least one memory controller and one or more memory devices.

### DETAILED DESCRIPTION

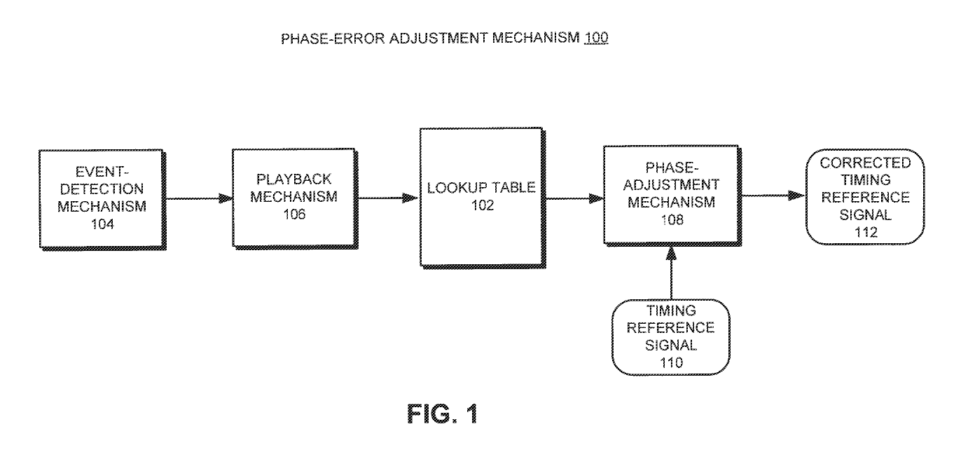

FIG. 1 presents a block diagram illustrating a phase-error adjustment mechanism 100 that dynamically compensates for phase error caused by a known transient event in a data communication system.

Specifically, phase-error-adjustment mechanism 100 includes a lookup table 102, which stores phase-error information associated with one or more known transient events which can occur during high-speed data communications. Each known transient event is a short-term event that has a deterministic component which is a unique and repeatable phase-error pattern and is associated with a constant or near constant duration. Consequently, the phase-error adjustment mechanism uses a sequence of one or more phase adjustment values, each linked to specific times during the progression of the event, to correct for this repeatable phase-error pattern.

Phase-error-adjustment mechanism 100 also includes an event-detection mechanism 104, which can detect a transient event prior to its occurrence, and can determine the type of the transient event if it is a known transient event. Event-detection mechanism 104 is coupled to a playback mechanism 106, which is coupled to lookup table 102. During a data communication operation, event-detection mechanism 104 can activate playback mechanism 106 when an upcoming transient event is detected. Upon activation, playback mechanism 106 plays back the sequence of one or more phase adjustment values associated with the detected event from lookup table 102, wherein the playback is synchronized with the occurrence of the detected event. The output of lookup table 102 is coupled to phase-adjustment mechanism 108, which also receives a timing reference signal 110. Phase-adjustment mechanism 108 uses the received phase-adjustment values from lookup table 102 to modify timing reference signal 110 to generate a corrected timing reference signal 112. Corrected timing reference signal 112 is then used to sample and recover the received data, thereby compensating for the phase error caused by the transient event. In a variation to the embodiment illustrated in FIG. 1, a phase detector and averaging module may be added to observe and average any residual phase error, and to update the lookup table by incrementing/decrementing table values to move the phase earlier or later for the next event. This phase detector and average module and associated data path are discussed in more detail below.

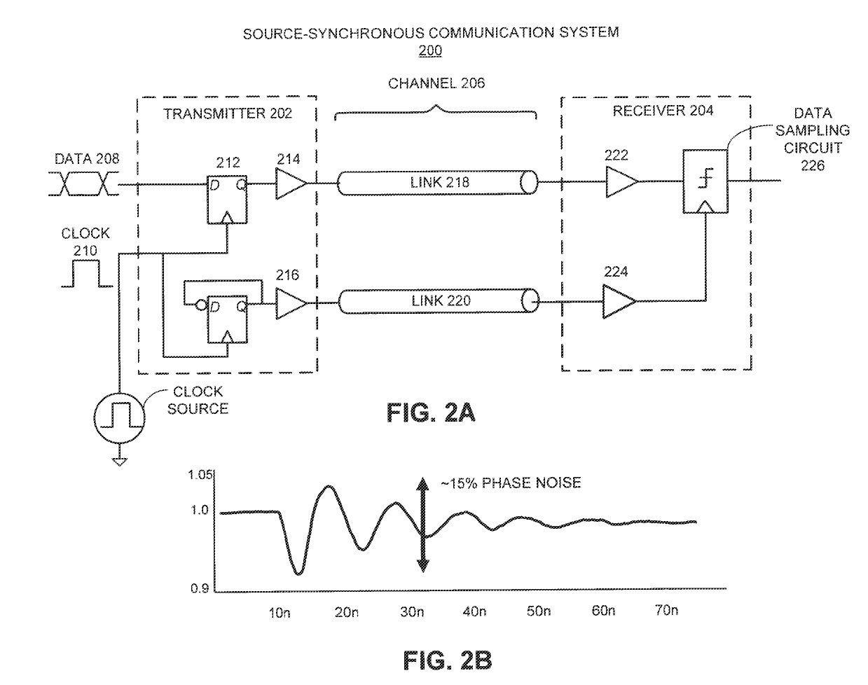

FIG. 2A presents a block diagram illustrating a source-synchronous communication system 200 which uses a receiver-side data detector for data-clock synchronization. As illustrated in FIG. 2A, communication system 200 includes a transmitter 202 (such as a memory controller), a receiver 204 (such as a memory chip), and a channel 206 coupled between transmitter 202 and receiver 204.

During operation, transmitter 202 receives as inputs data 208 and an associated timing reference signal 210. Transmitter 202 then uses a flip-flop 212 to synchronize timing reference signal 210 and data 208. Transmitter 202 additionally includes a data buffer 214 and a clock buffer 216 to buffer the data and the timing reference signal. Although communication system 200 is shown having a single data channel associated with a single timing reference signal, other embodiments can include more data channels associated with a common timing reference signal or separate timing reference signals.

Channel 206 includes a link 218 for transmitting data 208 and a link 220 for transmitting timing reference signal 210. The links 218 and 220 can include wires, transmission lines, or cables, and are matched so that the delays caused by channel 206 on data 208 and timing reference signal 210 are substantially the same. The timing reference signal 210 is transmitted alongside data 208 to provide a timing reference for data recovery purposes after data 208 is received at receiver 204. In some embodiments, data 208 and timing reference signal 210 can be source-synchronous signals that are generated by the same source device.

During operation, transmitter 202 sends data 208 and clock 210 over channel 206 to receiver 204, where the signals are received by a receiving data buffer 222 and a receiving clock buffer 224, respectively. Next, at receiver 204, a data sampling circuit 226 recovers the data 208 using the received timing reference signal 210. A transient event on either transmitter device 202 or receiver device 204 can cause significant skew on the phase relationship between the data and timing reference signal if this transient event is not properly corrected.

Some transient events (such as a RAS event on a DRAM) are repeatable and deterministic events which produce deterministic phase-error patterns. Consequently, the deterministic phase-error information from the onset of these transient events can be recorded and stored into a lookup table. For example, FIG. 2B illustrates a time-series phase waveform which is disrupted by a 15% phase-error disturbance during a power-transition event. The phase-error disturbance illustrated in FIG. 2B defines a transient event with approximately 50 ns duration but which dies out to <25% of its original magnitude within 20 ns. During a subsequent occurrence of the same transient event, the system plays back the inverse of the recorded phase errors from the lookup table in synchrony with the recurrence of the transient event, and thereby compensates for the phase errors caused by this event. The compensation applied from the table may be one or more values averaged from the accumulation of multiple occurrences of the same transient event. In this way, as the phase error experienced during subsequent recurrences is reduced by the correction, it is as if each phase table location has had an individual PLL for correction of the deterministic error component. To store phase-correction values for multiple different types of transient events, the lookup table can include multiple entries, where each entry (e.g., a row or a column of the lookup table) is used to store a time-sequence of phase-offset values associated with a specific transient event. Alternatively, multiple offset tables can be used, wherein each offset table is used to store a sequence of one or more phase-offset values associated with a specific transient event. The design principles presented above are not inconsistent with the use of a PLL in the receiver; that is to say, the phase compensation techniques presented in this disclosure may be advantageously used to supplement phase tracking provided by a receiver's PLL, e.g., to correct for transient event jitter outside of the loop bandwidth of the PLL.

Multiple table entries or multiple tables can each be driven by counters which operate at different frequencies. Specifically, to mitigate a short duration, high-frequency phase-error pattern caused by a high-frequency transient event (such as Vdd spiking or ringing), a high-frequency counter can be used to step through a corresponding lookup table rapidly. In contrast, a longer-duration, lower-frequency phase-error pattern caused by a low-frequency transient event (such as a temperature shift or system power supply drooping) can be compensated for by playing back a corresponding entry in the lookup table using a low-frequency counter.

To play back an entry set in a lookup table, the system uses phase-mixing circuitry to combine one or more phase-offset values from the lookup table with the phase of the timing reference signal as is obtained from the source (source-synchronous, transmitter-side or receiver-side PLL). Additionally, the system may use control logic circuitry to control the timing of the playback of the entry from the lookup table, and to update entries in the lookup table. In some embodiments, the lookup table, the phase mixing circuitry, and the control logic circuitry can exist on either the transmitter side or the receiver side of the data communication link. The modules for playing back the phase-offset value(s) and the phase detector for generating the phase-error information can form essentially a phase correction feedback loop for performing adaptive phase-error correction within the data communication system.

Note that the values in the lookup table entries may be hardwired into the lookup table (e.g., in the factory). In other embodiments, the values in the lookup table can be generated and trained during an online or offline process.

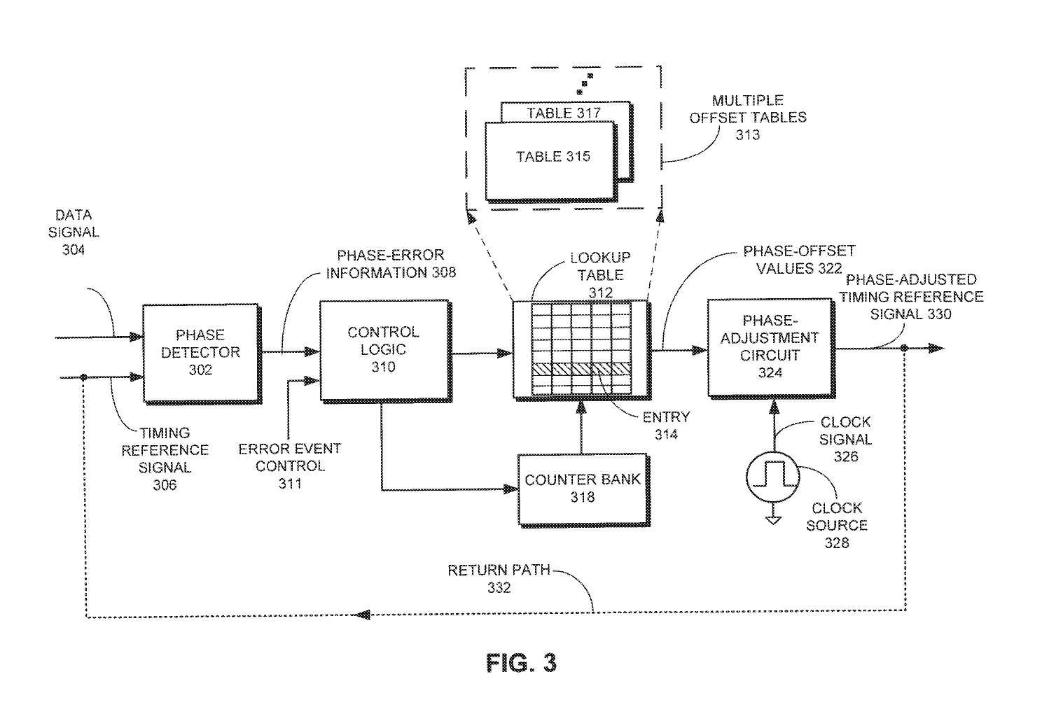

FIG. 3 presents a block diagram illustrating a process for updating a lookup table associated with a transient event, and for compensating for the phase errors caused by the transient event. This process may be used in the context of communication system 200 illustrated in FIG. 2A. While the system described below can be used to playback as little as a single correction value, it should be assumed for purposes of the discussion below that a time-based series of several values is typically played back, to compensate for transients that persist for a number of clock cycles.

As seen in FIG. 3, a phase detector 302 compares phases between data signal 304 and associated timing reference signal 306, and subsequently generates phase-error information 308. In particular, phase-error information 308 is produced during an occurrence of a specific transient event (e.g., a power-on event). In some embodiments, phase detector 302 is a binary phase detector, which outputs “early/late” binary phase relationship information between the data and timing reference signals. For example, phase detector 302 can be an edge detector, which uses a 90° phase shift to align the edges of timing reference signal 306 with data transitions in data signal 304, and then compares the edge positions of the timing reference signal with the positions of the data transitions. In some embodiments, the phase comparisons are performed at each clock edge (e.g., both positive and negative edges for DDR clocking), and the phase error outputs are spaced by corresponding unit intervals (UIs). The phase comparisons can be performed every N clock edges, where N>1. A larger N value may be used for low-frequency events (e.g., temperature drift) to reduce the number of phase-error values which have to be stored for these events.

Phase-error information 308 is received by control logic 310, which is coupled to a lookup table 312. The lookup table 312 can include one or more entries (e.g., multiple rows in lookup table 312), wherein each entry 314 (i.e., each row in lookup table 312) is associated with a specific type of transient event. Each entry 314 contains a time-sequence of phase-offset values, which corresponds to the duration of the transient event. Alternatively, multiple offset tables 313 can be used in place of single lookup table 312, wherein each offset table is used to store a time-based sequence of phase-offset values associated with a specific transient event within multiple transient events. For example, a table 315 within multiple offset tables 313 is used to store phase-offset values for a RAS event, a table 317 is used to store phase-offset values for a power-on event, and so on.

Control logic 310 additionally receives an error event control 311, which contains information on the type of transient event that is being monitored. Hence, upon receiving phase-error information 308, control logic 310 updates the values of a corresponding event entry 314 in lookup table 312. When the phase-error information comprises binary values which originate from a binary phase detector, control logic 310 can update the values by individually incrementing or decrementing the set of values in the entry 314 based on the binary phase information. In the cases of using multiple offset tables 313, control logic 310 can be used to identify and select a particular table from the multiple tables to update the associated table values.

Although lookup table 312 is illustrated as containing multiple entries, in some embodiments, lookup table 312 can contain just a single entry. This single entry in lookup table 312 can be used to store phase-offset values for one specific type of transient event. Furthermore, this single entry can store just a single offset value (which can be implemented by a single register, a single capacitor, etc).

Additionally, control logic 310 can be simultaneously configured to drive lookup table 312 to play back the stored phase-offset values during an occurrence of a transient event. To correctly compensate for the phase errors caused by the transient event, the playback of the phase-offset values is ideally time-aligned with the occurrence of the transient event. As such, the “record” and “playback” operations to and from the lookup table may be configured to occur at distinctly different times, or they may occur at the same time with updates to the table ‘queued’. In one embodiment, control logic 310 may be configured to compute offset “delta” values with respect to any current table entries, and to update table entries milliseconds after attenuation of the transient event in question. If desired, error event control 311 can also include an alignment control associated with the transient event, which can be used by control logic 310 to synchronize the playback with the onset of the transient event.

The playback speed may be determined based on the speed of the event being compensated for. For example, high-frequency events can be compensated for by playing back a compensation for every sequential data bit (or every clock transition), while low-frequency events can be compensated for by playing back the best average compensation for a set of N consecutive data bits. Counters of different speeds can be used to control the speed with which the system steps through lookup table entries.

In some embodiments, the ‘step’ function in phases that are accomplished by the distinct different entries in the lookup table can be linearized by circuitry in the phase adjustment circuit 324 to provide a direct ramp in phase between any two distinct settings from the lookup table 312.

As seen in FIG. 3, a phase-adjustment circuit 324 receives phase-offset values 322 from lookup table 312, and additionally receives a clock signal 326 from a clock source 328. Phase-adjustment circuit 324 then uses phase-offset values 322 to adjust clock signal 326 (e.g., via a phase mixer) to compensate for the phase jitter caused by the associated transient event, and outputs phase-adjusted timing reference signal 330, which is subsequently used to sample and recover the received data signal 304. Phase-adjustment circuit 324 can also use the phase-offset values 322 to adjust the phase of data signal 304 relative to clock signal 326.

Phase detector 302 and control logic 310 can be implemented on the same side or on opposite sides of a data communication channel. If they are located on opposite sides, phase-error information 308, or a distilled or averaged version of phase-error information 308, can be communicated across the channel through a data link for use at the other side of the channel.

The lookup table updating process illustrated in FIG. 3 may be used in a “loop mode” by coupling the phase-adjusted timing reference signal 330 to the timing reference signal input of phase detector 302. For example, a return path 332 (shown in dashed line) coupled between phase adjustment circuit 324 and phase detector 302 can be used for returning the phase data. After receiving phase-adjusted timing reference signal 330 through return path 332 and data signal 304, phase detector 302 generates updated phase-error information 308 to update the values for an entry (e.g., entry 314) in the lookup table 312. This loop mode may be used to concurrently perform phase correction by updating the lookup table at run-time (i.e., during actual data communication). This phase correction can be carried out during actual data communication and may be used to update the lookup table after each occurrence of a transient event. The loop mode may be particularly useful for deterministic events with a phase-error magnitude or periodicity which is difficult to predict or compensate for (such as power-supply ringing). In some embodiments, the return path 332 is not used.

Lookup table 312 may be trained through an offline process. At the start of the training process, an entry in lookup table 312 can be cleared or preloaded with the previously established values. During the training process, the phase-error information produced by phase detector 302 can be used to increment/decrement the phase-offset values in the entry in lookup table 312. The training process can be terminated when the phase-offset values in the lookup table become stable.

In other embodiments, the lookup table updating process illustrated in FIG. 3 may be used in a non-loop mode. In this case, phase detector 302 may be disabled and the system can play back the pre-established phase-offset values from an entry in lookup table 312 for a known transient event. Such pre-established values could be determined in advance based on system specifics or could be measured and recorded after power-up in a configuration sequence. In these embodiments, lookup table 312 maintains fixed phase-offset values which are not updated during actual data communication. Alternatively, if appropriate to the embodiment, phase-offset values can be trained for a short period of time or to reflect a fixed number of updates, with the loop subsequently disabled.

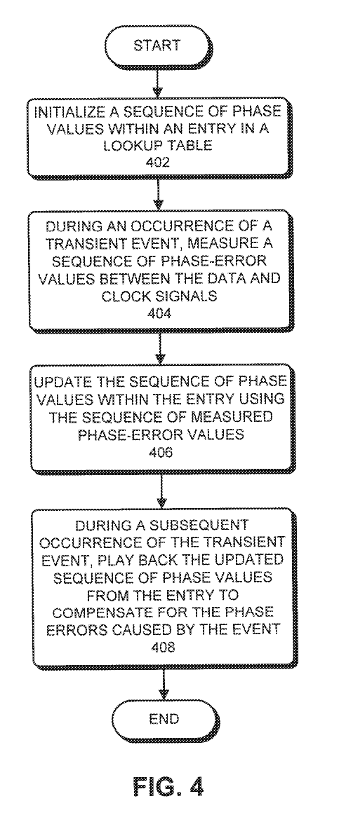

FIG. 4 presents a flowchart illustrating a process for updating a lookup table during a transient event to compensate for the phase errors. During operation, the system initializes a time sequence of phase values within an entry in a lookup table (step 402). The initial values can be predetermined values based on previous measurements of phase errors. Alternatively, the system can initialize the entry simply by clearing the values. The lookup table can be kept at either the transmitter side or receiver side of the data communication channel.

During an occurrence of a transient event, the system measures a sequence of phase-error values between the data and timing reference signals (step 404). The duration of the transient event commences at start of the transient event and ends when the system restabilizes (which may be defined as when the phase error caused by the event drops below a threshold value). For example, a power-on event may cause ringing in the phase relationship between the data and the timing reference signal which can last for multiple clock cycles. If the transient state is relatively short, say ˜20 ns, then the phase-error values may be collected at a short time interval, for example at every clock edge. On the other hand, if the transient state is relatively long, say hundreds of ns, the phase-error values may be collected during a longer time interval, for example once every 16 clock edges, or accumulated/averaged over a longer interval. Phase errors collected over longer intervals can be optionally averaged to determine the best phase-error correction value spanning all the edges.

The system can use a binary phase detector to obtain the phase-error values, where each phase-error value is a binary value which indicates an early/late relationship between the phases of the data and timing reference signals. Notably, the design of some memory systems features a timing signal that is transmitted 90° out of phase with data, i.e., such that an edge of the timing signal may be used to sample data lines at the expected center of a data unit interval. In these systems, the receiver may use a delay element to edge-align the timing reference signal and a data signal so that an edge detector may produce an edge-based binary phase comparison (notwithstanding transmitter misalignment of the timing reference signal and data transitions). In this way, the phase-error values can be generated to represent the “early/late” relationship between the timing reference edges and the data transitions.

Next, the sequence of phase-error values produced by the phase detector is used to update an entry within the lookup table (step 406). As described above in conjunction with FIG. 3, this step may be performed by control logic coupled between the phase detector and the lookup table. More specifically, the control logic can be used to increment/decrement each value in the entry using a corresponding binary phase-error value. The control logic may select the entry for the transient event from a set of entries within the lookup table. Hence, the control logic is capable of identifying different deterministic transient events. The lookup table can also be used to store either phase-error information or phase correction information directly (i.e., the inverse of the phase-error information), depending upon system implementation and configuration of correction circuitry.

During a subsequent occurrence of the same transient event and concurrent data communication, the system may play back the updated time sequence of phase correction values (i.e., the inverse of the phase errors) from the lookup table in lockstep with the transient event, thereby compensating for the phase errors caused by the event (step 408). As described above in conjunction with FIG. 3, this step may be controlled by the control logic. To synchronize playback, the control logic may receive additional timing signals associated with the transient event.

As mentioned above, using the phase-offset values to compensate for the phase errors can include mixing the phase-correction values with the existing phase between the data and time reference signals in whatever form they may already be present in the system; the time reference signals may be source-synchronous or may have been derived from a PLL/DLL. In some cases, this phase-mixing operation may require additional circuits, such as a phase shifter, phase summer, or phase mixer.

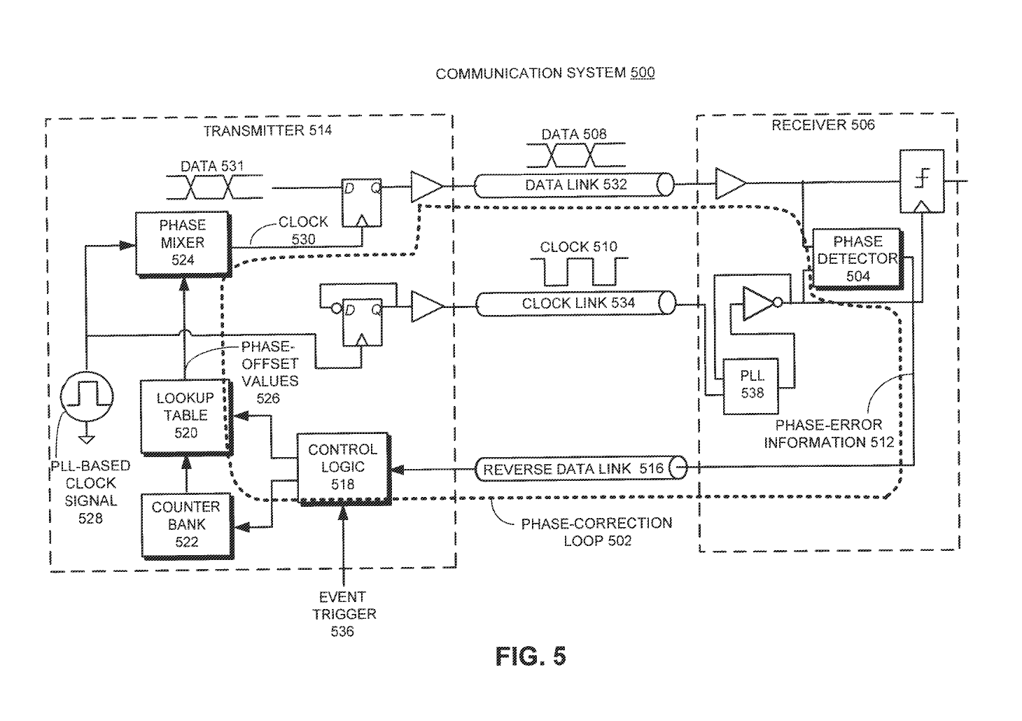

FIG. 5 presents a block diagram illustrating a data communication system 500 which uses a phase-correction loop 502 and a transmitter-side lookup table 520 to provide phase compensation during a transient event. Phase-correction loop 502 includes a phase detector 504 located on receiver 506. Phase detector 504 receives as inputs both data 508 and clock 510. During operation, phase detector 504 can continue monitoring the phase relationship between the data and timing reference signals to produce phase-error information 512. If desired, this information can be averaged and accumulated on receiver 506 before being sent back to transmitter 514 through a reverse data link 516 in order to minimize the bandwidth required for communication over reverse data link 516.

Referring to phase-correction loop 502, phase-error information 512 can be sent back to transmitter 514 through a reverse data link 516. The transmitter side of the phase correction loop includes control logic 518, lookup table 520, counter bank 522, and phase mixer 524. As described above, control logic 518 receives phase-error information 512 and then updates phase-offset values in one of the entries in lookup table 520. Control logic 518 is also responsible for controlling the playback of phase-offset values 526, which comprises the inverse of the phase-error disturbance caused by a deterministic event.

Phase-offset values 526 from lookup table 520 are received by phase mixer 524. Phase mixer 524 can further include a phase summer which adds the phase of a PLL-based timing reference signal 528 and phase-offset values 526. The phase mixer 524 generates a phase-adjusted timing reference signal 530, which is used to clock the input data 531 and generate phase-adjusted data 508, thereby introducing the phase offsets between data signal 508 and timing reference signal 528. To complete phase correction loop 502, phase-adjusted data 508 and regular timing reference signal 528 are sent over respective links 532 and 534, which are received by receiver 506. Alternatively, an unadjusted data signal 508 (i.e., the input data 531) and a phase-adjusted timing reference signal 530 can be sent over respective links 532 and 534. In this case, the phase corrections would be inverted in polarity (e.g. early→late and late→early) in relation to the embodiment shown in FIG. 5.

To synchronize the lookup table playback with an occurrence of a deterministic event, control logic 518 can additionally receive an event trigger 536. When event trigger 536 is received, control logic 518 determines the specific type of event based on the event trigger. Control logic 518 then starts a predetermined countdown toward the start of the record and play back. This allows time for synchronizing both the record and the playback with the event. During the countdown, control logic 518 can also select an entry associated with the triggering event in lookup table 520 or dedicated table, and an appropriate counter in counter bank 522 for controlling the playback speed. When the countdown is completed, the selected counter starts to step through the selected entry to read out phase-offset values 526 from lookup table 520. In the system shown in FIG. 5, a PLL 538 is included on receiver 506. In some cases, phase-correction loop 502 is used for high-frequency deterministic phase-noise measurement and correction while PLL 538 is used for lower-frequency phase-noise correction.

In some embodiments, the system may not have to use the full-phase-correction loop 502 after the lookup tables have been trained and deterministic values have been stored in the lookup table (hence, no further update is required). In these embodiments, only the transmitter side of the loop is used. More specifically, control logic 518 is only activated when triggered by a deterministic event. Control logic 518 then enables the playback of the corresponding entry in lookup table 520 to compensate for the phase-error disturbance caused by the event. This is particularly useful when reverse data link 516 is not available for normal operation but only during training sequences or for periodic updates. Such periodic updates can often be accommodated by time-multiplexing the information onto links which are not used during certain events, such as refresh on a memory device.

The entire phase-correction loop 502 may be kept active during regular data communication. More specifically, phase detector 504 can continue producing phase-error information 512 and can send it (or a distilled/averaged version of it) back to control logic 518, which then updates lookup table 520. One application of this operating mode is to adaptively learn and compensate for a new type of transient event during data communication. In this case, the system does not have to have a priori knowledge of an incoming transient event. However, control logic 518 is notified of the timing of the event, for example, through an event trigger which is correlated to the event. Hence, in this operating mode, the system can learn and build new entries in lookup table 520 (or new tables) for unknown transient events on the fly. New events can thus be compensated for through repeated training of the effect of those events before ‘live’ or ‘critical’ data is associated with those events

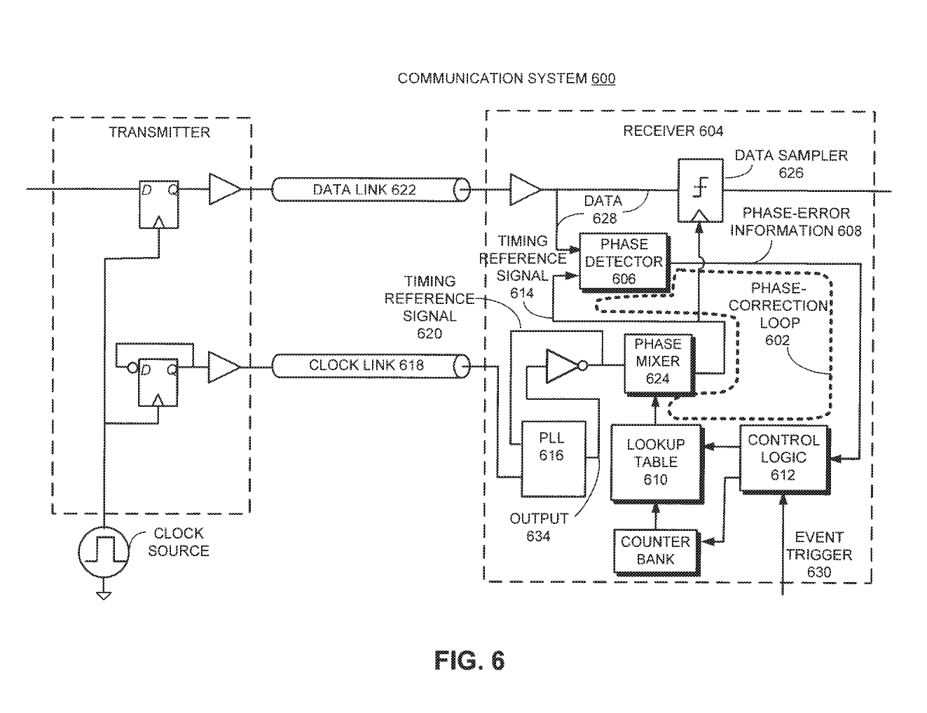

FIG. 6 presents a block diagram illustrating a data communication system 600 having a phase-correction loop 602 (indicated by the dashed line) and a lookup table 610 located on receiver 604. In this system, the phase correction also takes place on receiver 604.

More specifically, phase detector 606 in phase-correction loop 602 produces phase-error information 608 which is used to update lookup table 610 through control logic 612. Phase detector 606 is configured in a similar manner as phase detector 504 in FIG. 5. However, while phase detector 504 in FIG. 5 can be used to adjust either the data signal or the time reference signal, phase detector 606 in FIG. 6 is primarily used to adjust the timing reference signal (e.g., time reference signal 614). A receiver-side PLL 616 is present in the clock path to compensate for delay differences between the clock link 618 and data link 622. Alternatively, a DLL may be used in place of PLL 616. The delay differences between the clock and data links typically arise from skew between the data link and the clock link. PLL 616 outputs a de-skewed timing reference signal 620, which is the input to phase mixer 624 in phase-correction loop 602. Phase mixer 624 then adds phase corrections into timing reference signal 620 based on the outputs from lookup table 610, and outputs phase-adjusted timing reference signal 614. Phase-adjusted timing reference signal 614 is then compared with received data 628 by phase detector 606. Additionally, phase-adjusted timing reference signal 614 is used to clock data sampler 626 to recover data 628. In the system illustrated in FIG. 6, phase correction is achieved by directly modifying the phase control output 634 of PLL 616. In this embodiment, the operation of phase-correction loop 602 is substantially the same as phase-correction loop 502, and hence is not described in more detail.

Putting the entire phase-correction loop 602 on the receiver side eliminates the need for a reverse data link to return the phase-error information to the transmitter. Control logic 612 can receive event trigger 630 on receiver 604. This may be preferable when the event trigger is available on the receiver.

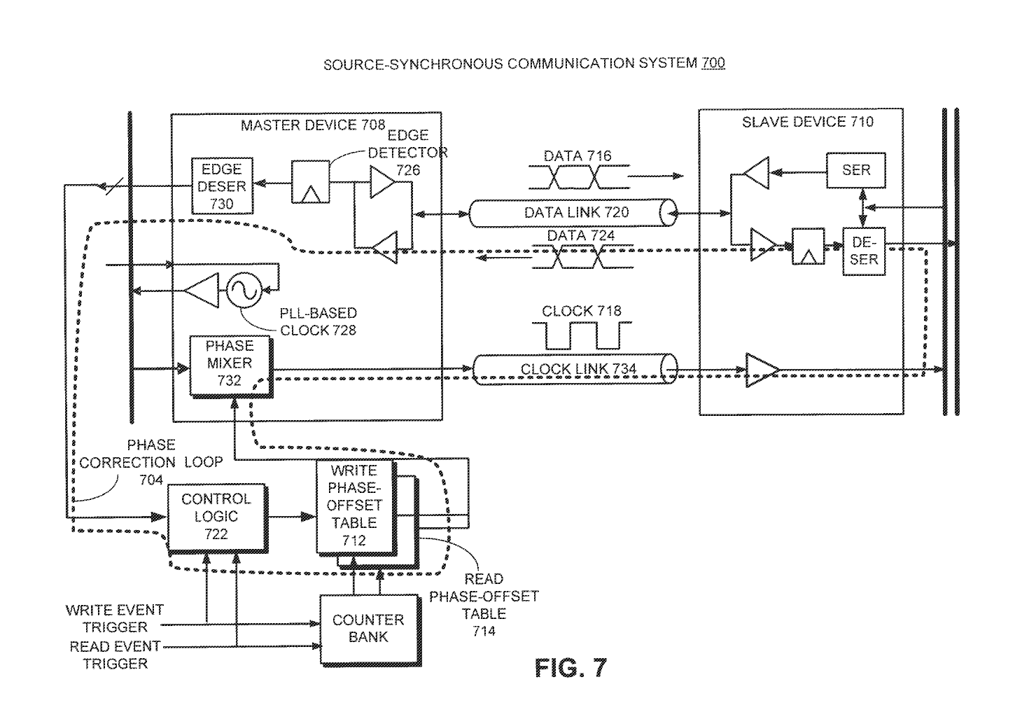

FIG. 7 presents a block diagram illustrating a source-synchronous master/slave data communication system 700 having a transient-event phase-correction loop 704 (indicated by the dashed line) and two lookup tables 712 and 714 located on the master side of the system. The system 700 is configured to perform both write operations (i.e., sending data from master device 708 to slave device 710) and read operations (i.e., sending data from slave device 710 to master device 708), and the phase-correction loop 704 uses separate lookup tables 712 and 714 for write and read operations.

More specifically, during a write-related transient event, phase-error information between write data 716 and timing reference signal 718 is recorded using a phase detector on slave device 710. This phase-error information can be sent to master device 708 over a reverse data link or via bi-directional data link 720 itself at a later time. Control logic 722 then writes phase-error information for the write operation in write lookup table 712 for later write correction at the next event recurrence as described above.

During a read-related transient event, read data 724 is sent over bi-directional data link 720 and is received by master device 708. Next, an edge detector 726 recovers data 724 using a local timing reference signal generated by a clock source 728 (i.e., a LC-PLL in this case) on master device 708. Clock 728 is not source synchronous to read data 724. Next, the output from edge detector 726 is deserialized by an edge-deserializer 730. The output from edge-deserializer 730, which contains “early/late” phase-error information, is sent to control logic 722. Control logic 722 averages the information and updates corresponding entries within read lookup table 714.

In addition to the phase-error information, control logic 722 receives separate event triggers, one for the write transient event and one for the read transient event. More specifically, when a transient event is about to happen, control logic 722 determines if the system is in write mode or read mode, and can then choose a corresponding lookup table for playing back phase-offset values as the transient event occurs.

During phase correction on a write transient event, the output from write lookup table 712 offsets the phase of clock 728 using a phase mixer 732 on master device 708. Master device 708 then sends the phase-adjusted timing reference signal 718 and a source-synchronous data 716 to slave device 710 over clock link 734 and data link 720. During phase correction for a read operation, phase-adjusted timing reference signal 718 is also sent to slave device 710 over clock link 734. The received timing reference signal is then returned from master device 708 with read data 724, and is used to recover read data 724 on master device 708. In both types of operations, phase-adjusted timing reference signal 718 compensates for the phase errors caused by transient events. In the case of write operations (as was discussed in connection with FIG. 5), the correction could alternately be applied to the data link 720 or the clock link 734 (as shown), depending on system implementation.

Phase-correction operations can be used to compensate for phase-disturbance events which can occur on either the master or the slave side of the communication channel. As long as an event trigger can correctly correlate the event to the lookup table playback, the phase-error disturbance can be compensated.

Because the above-described clock-data phase-adjustment technique is applicable to source-synchronous communication within a computer memory, this technique can be used in any system that includes a source-synchronous dynamic random access memory device (DRAM). Such a system can be, but is not limited to, a mobile system, a desktop computer, a server, and/or a graphics application. Moreover, the DRAM may be, e.g., graphics double data rate (GDDR, GDDR2, GDDR3, GDDR4, GDDR5, and future generations), and double data rate (DDR2, DDR3 and future memory types). The source-synchronous techniques described may be applicable to other types of memory, for example flash and other types of non-volatile memory, as well as volatile static random access memory (SRAM). Moreover, one or more of the techniques described herein are applicable to a front-side bus, (i.e., processor-to-bridge chip, processor to processor, and/or other types of chip-to-chip interfaces). Also, two communicating integrated circuit (IC) chips (i.e., the transmitter and receiver) can be housed in the same package, e.g., in a stacked-die approach. If desired, the transmitter, receiver and the channel can all be built on the same die in a system-on-a-chip (SOC) configuration.

It should be understood that a timing reference signal in the context of the instant description may be embodied as a strobe signal or other signal that conveys a timing reference and is not limited to a signal that is strictly periodic. For example, the timing reference signal may be a strobe signal that is aperiodic in the sense that transitions only occur when data is being transmitted. In general, the timing reference signal may be any type of signal that conveys timing information (e.g., temporal information that indicates that data is valid).

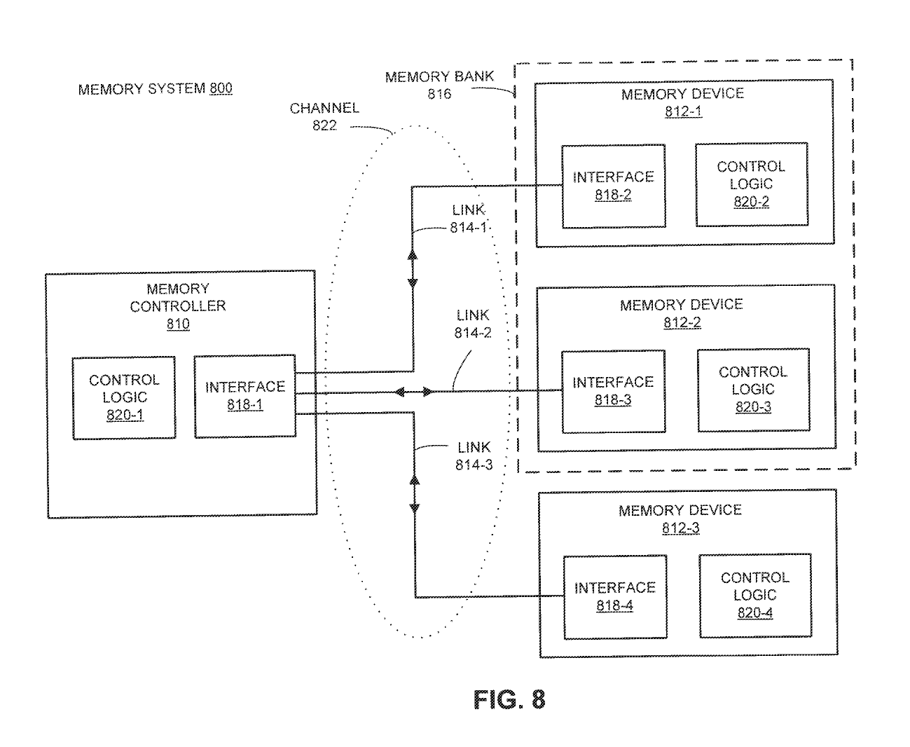

Additional embodiments of systems, such as memory systems, that may use one or more embodiments of the above-described technique are described below. FIG. 8 presents a block diagram illustrating an embodiment of a memory system 800, which includes at least one memory controller 810 and one or more memory devices 812. While FIG. 8 illustrates memory system 800 with one memory controller 810 and three memory devices 812, other embodiments may have additional memory controllers and fewer or more memory devices 812. While memory system 800 illustrates memory controller 810 coupled to multiple memory devices 812, in other embodiments two or more memory controllers may be coupled to each other. Memory controller 810 and one or more of memory devices 812 may be implemented on the same or different integrated circuits, and that the one or more integrated circuits may be included in a chip-package.

Memory controller 810 can be a local memory controller (such as a DRAM memory controller) or a system memory controller (which may be implemented in a microprocessor). Memory controller 810 may also include an I/O interface 818-1 and control logic 820-1. Also, one or more of memory devices 812 can include control logic 820 and at least one of interfaces 818. If desired, memory controller 810 and/or one or more of memory devices 812 may include more than one of the interfaces 818, and these interfaces may share one or more control logic 820 circuits. Also, two or more of the memory devices 812, such as memory devices 812-1 and 812-2, may be configured as a memory bank 816.

As discussed in FIG. 5 and FIG. 7, control logic 820-1 may be used to update the lookup table entries and control playback of the phase-offset values from the lookup table entries to compensate for phase errors between data signal and associated clock signals transmitted between memory controller 810 and three memory devices 812. Alternatively, as in the case of FIG. 6, these functions can also be accomplished by using control logic 820-2 to 820-4 located on memory devices 812.

Memory controller 810 and memory devices 812 are coupled by one or more links 814, such as multiple wires, in a channel 822. While memory system 800 is illustrated as having three links 814, other embodiments may have fewer or more links. These links may provide wired, wireless, optical, bi-directional and/or uni-directional communication between the memory controller 810 and one or more of the memory devices 812, if desired, in a simultaneous manner (e.g., full-duplex communication).

Phase-correction information can be shared across a parallel bus. In this regard, a single data line within the parallel bus can be used as a reference for phase-error information and other data lines within the parallel bus can use the same corrected clock and thus use its phase-error correction in-common.

This disclosure has described exemplary techniques for dynamically correcting transient phase errors between data and a timing reference signal caused by an event during data communication between a transmitter and a receiver. During operation, a system exemplifying these techniques stores one or more phase-offset values for the event in an offset table, where the constituent phase-offset values are associated with phase error caused by the event. Upon detecting a subsequent occurrence of the event, the system adjusts the phase relationship between the data and the timing reference signal based on the one or more phase-offset values.

The system can adjust the phase relationship between the data and the timing reference signal by outputting the one or more phase-offset values from the offset table at a speed based on the duration of the event.

The system can also train the phase-offset values in the offset table during multiple occurrences of the event. More specifically, the system can train the phase-offset values during multiple occurrences of the event through an iterative process. The system can start by initializing an array of phase values within the offset table to represent the time-based series of phase-offset values. Next, the system can iteratively: (1) measure a sequence of phase-error values between the data and timing reference signals during an occurrence of the event, where each phase-error value is a binary value which indicates an early/late relationship between the data and the timing reference signals; (2) use the sequence of phase-error values to update the array of phase values within the offset table entry; and (3) output the updated array of phase values from the offset table entry in synchrony with a subsequent occurrence of the event, to compensate for the phase errors caused by the event. Consequently, the system can iteratively update the array of phase values within the offset table.

The system can adjust the phase relationship between the data and the timing reference signal based on the one or more phase-offset values by first mixing the one or more phase-offset values with the phase of the timing reference signal to generate a phase-adjusted timing reference signal. The system then sends the phase-adjusted timing reference signal with the data signal from the transmitter to the receiver to compensate for the phase errors caused by the event.

This disclosure has also described a device that dynamically corrects phase errors between data and a timing reference signal caused by an event during a data communication operation. The device can include an offset table configured to store one or more phase-offset values for the event, where the phase-offset values are associated with phase error caused by the event. The device may include a detection mechanism for detecting a subsequent occurrence of the event, and control logic configured to adjust the phase relationship between the data and the timing reference signal based on the one or more phase-offset values.

Still further, this disclosure has also described a communication system. The communication system can include a transmitter, a receiver, and a communication channel coupled between the transmitter and the receiver. An offset table may be configured to store one or more phase-offset values for the event, where the phase-offset values are associated with phase error caused by the event. If desired, the communication system can also include a detection mechanism for detecting a subsequent occurrence of the event, and control logic configured to adjust the phase relationship between the data and timing reference signals.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method of operation in a system that employs a timing reference signal in support of communication between a transmitter and a receiver, the method comprising:
storing information defining adjusted operation of a first timing signal for a transient period following a predetermined event;
upon occurrence of the predetermined event, using the stored information to produce a corrected timing signal based on the first timing signal as the timing reference signal; and
following the transient period, employing the first timing signal as the timing reference signal without using the stored information to produce a corrected timing signal.

2. The method of claim 1, where the stored information is to adjust edges of the first timing signal to produce the corrected timing reference signal.

3. The method of claim 2, where the stored information represents early/late information for individual edges of the first timing signal relative to timing of the communication.

4. The method of claim 1, where the predetermined event represents a transient event.

5. The method of claim 1,
wherein storing the information includes storing one or more phase-offset values for the predetermined event, wherein the one or more phase-offset values are associated with phase errors caused by the predetermined event; and
wherein producing the corrected timing reference signal involves adjusting a phase relationship between the data and the one or more edges of the timing reference signal based on the one or more phase-offset values.

6. The method of claim 5, wherein adjusting the phase relationship between the data and the timing reference signal includes outputting the one or more phase-offset values at a speed which is based on duration of the predetermined event.

7. The method of claim 5, wherein the method further comprises training the one or more phase-offset values during multiple occurrences of the predetermined event.

8. The method of claim 7, wherein training the one or more phase-offset values during multiple occurrences of the predetermined event includes:
initializing an array of phase values to represent a time-based series of phase-offset values; and
iteratively,
measuring a sequence of phase-error values between the data and the timing reference signal during an occurrence of the predetermined event, wherein each phase-error value is a binary value which indicates an early/late relationship between the data and the timing reference signal;
using the sequence of phase-error values to update the array of phase values; and
outputting the updated array of phase values in synchrony with a subsequent occurrence of the predetermined event to compensate for the phase error caused by the predetermined event.

9. The method of claim 8, wherein measuring the sequence of phase-error values between the data and the timing reference signal includes using a binary phase detector to compare the phase relationship between the data and the timing reference signal.

10. The method of claim 8, wherein measuring the sequence of phase-error values between the data and the timing reference signal includes sampling the phase difference between the data and the timing reference signal at an interval spanning one or multiple clock transitions.

11. The method of claim 5, wherein the method further comprises determining the duration of the phase error and defining the series in a manner that corrects for the phase error throughout the duration.

12. The method of claim 5, wherein adjusting the phase relationship between the data and the timing reference signal based on the one or more phase-offset values further includes:
mixing the one or more phase-offset values with the phase of the timing reference signal to generate a phase-adjusted timing reference signal; and
sending the phase-adjusted timing reference signal with the data from the transmitter to the receiver.

13. The method of claim 5, wherein adjusting the phase relationship between the data and the timing reference signal based on the one or more phase-offset values further includes:
mixing the one or more phase-offset values with the phase of the timing reference signal to generate a phase-adjusted timing reference signal;
generating phase-adjusted data by synchronizing the data with the phase-adjusted timing reference signal; and
sending the phase-adjusted data with the timing reference signal from the transmitter to the receiver.

14. The method of claim 5, wherein adjusting the phase relationship between the data and the timing reference signal includes using control logic to synchronize the output of the one or more phase-offset values with the occurrence of the predetermined event.

15. The method of claim 14, wherein using the control logic to synchronize the output with the occurrence of the predetermined event includes using an event trigger correlated with the predetermined event to trigger a countdown toward the predetermined event by the control logic.

16. The method of claim 5, wherein the method further comprises using multiple sets of phase-offset values, wherein each set of phase-offset values is used to compensate for phase errors caused by a different one of multiple predetermined events.

17. The method of claim 1, wherein the predetermined event is one of:
a power-on event;
a row access strobe (RAS) event; and
a clock-on event.

18. A device that uses a timing reference signal in support of communication between a transmitter and a receiver, the device comprising:
a storage structure to store information defining adjusted operation of a first timing signal for a transient period following a predetermined event; and
control logic,
wherein upon occurrence of the predetermined event, the control logic uses the stored information to produce a corrected timing signal based on the first timing signal as the timing reference signal, and
wherein following the transient period, the control logic uses the first timing signal as the timing reference signal without using the stored information to produce a corrected timing signal.

19. The device of claim 18, where the stored information is used to adjust edges of the first timing signal to produce the corrected timing reference signal.

20. The device of claim 19, where the stored information represents early/late information for individual edges of the first timing signal relative to timing of the communication.

21. The device of claim 18, where the predetermined event represents a transient event.

22. The device of claim 15, wherein the storage structure is to store one or more phase-offset values for the predetermined event, wherein the one or more phase-offset values are associated with phase errors caused by the predetermined event; and
wherein the control logic is to adjust the timing reference signal by adjusting a phase relationship between the data and the one or more edges of the timing reference signal based on the one or more phase-offset values.

23. The device of claim 22, further comprising a timing circuit coupled to the storage structure, wherein the timing circuit is to adjust the phase relationship between the data and the timing reference signal by outputting the one or more phase-offset values from the storage structure at a speed which is based on duration of the predetermined event.

24. The device of claim 22, further comprising a phase mixer, wherein the phase mixer is to adjust the phase of the timing reference signal using the one or more phase-offset values in synchrony with the occurrence of the predetermined event to generate a phase-adjusted timing reference signal.

25. The device of claim 24, further comprising a phase detector configured to measure a sequence of phase-error values between a data signal and the timing reference signal during the predetermined event, wherein each phase-error value is a binary value which indicates an early/late relationship between the data and the timing reference signal.

26. The device of claim 25, wherein the timing reference signal is the phase-adjusted timing reference signal.

27. The device of claim 15, wherein the phase detector is an edge detector which is configured to compare the phase relationship between the data and the timing reference signal.

28. The device of claim 27, wherein the edge detector is configured to compare the phase relationship between the data and the timing reference signal by sampling the phase difference between the data and the timing reference signal at an interval of one or multiple clock transitions.

29. The device of claim 25, wherein the phase detector is coupled to the control logic, which uses the sequence of phase-error values to update the phase-offset values within the storage structure.

30. The device of claim 25, wherein the phase detector, the control logic, the storage structure, and the phase mixer form a phase-correction loop within the device.

31. The device of claim 30, wherein the phase-correction loop is configured to adaptively correct phase errors between the data and the timing reference signal caused by the predetermined event during memory operations.

32. The device of claim 18, wherein the storage structure further comprises multiple storage structure entries for compensating for phase errors caused by multiple predetermined events.

33. The device of claim 32, wherein the control logic is configured to select a storage structure entry from the storage structure based on the predetermined event.

34. The device of claim 18, further comprising multiple storage structures, wherein each storage structure is used to compensate for phase errors caused by a different one of multiple predetermined events.

35. The device of claim 34, wherein the control logic is configured to select a storage structure from the multiple storage structures based on the predetermined event.

36. The device of claim 18, wherein the device is embodied as an integrated circuit.

37. The device of claim 18, wherein the device is embodied as a memory controller.

38. The device of claim 18, wherein the device is embodied as a memory device.

39. The device of claim 18, wherein the device is a source-synchronous device.

40. A communication system, comprising:
a transmitter;
a receiver;
a communication channel coupled between the transmitter and the receiver;
a storage structure to store information defining adjusted operation of a first timing signal for a transient period following a predetermined event;
control logic, wherein upon occurrence of the predetermined event, the control logic uses the stored information to produce a corrected timing signal based on the first timing signal as a timing reference signal; and
wherein following the transient period, the control logic uses the first timing signal as the timing reference signal without using the stored information to produce a corrected timing signal.

41. The communication system of claim 40, where the stored information is used to adjust edges of the first timing signal to produce the corrected timing reference signal.

42. The communication system of claim 41, where the stored information represents early/late information for individual edges of the first timing signal relative to timing of the communication.

43. The communication system of claim 40, where the predetermined event represents a transient event.

44. The communication system of claim 40, wherein the storage structure is to store one or more phase-offset values for the predetermined event, wherein the phase-offset values are associated with phase errors caused by the predetermined event; and
wherein the control logic is to adjust the timing reference signal by adjusting a phase relationship between the data and the one or more edges of the timing reference signal based on the one or more phase-offset values.

45. The communication system of claim 40, wherein the storage structure is implemented in the receiver.

46. The communication system of claim 40, wherein the detection mechanism is implemented in the receiver.

47. The communication system of claim 40, wherein the control logic is implemented in the receiver.

48. The communication system of claim 40,
wherein the communication system is a source-synchronous memory system; and
wherein the control logic is implemented in a memory controller.
